(19) United States
(12) Patent Application Publication
(10) Pub. No.: US 2023/0006845 A1
(43) Pub. Date: Jan. 5, 2023

(54) SYSTEMS AND METHODS FOR BLOCKCHAIN STORAGE OF DATA GENERATED VIA PAIRED SMARTPHONE AND SMARTWATCH

(71) Applicant: SYFEREX, LLC, West Palm Beach, FL (US)

(72) Inventor: Charles M. Leedom, JR., Locust Grove, VA (US)

(73) Assignee: SYFEREX, LLC, West Palm Beach, FL (US)

(21) Appl. No.: 17/499,397

(22) Filed: Oct. 12, 2021

(51) Int. Cl. H04L 9/00

(52) U.S. Cl. CPC H04L 9/50

(57) ABSTRACT

A portable computing devices provides control over data generated thereby over time during operation by the user. The device includes a processor configured to execute a DApp including a smart contract and blockchain. The DApp includes commands, that when executed cause the smartphone to receive user defined criteria for the smart contract to use in selecting data generated at successive times during operation of the smartphone, for immutable storage in the blockchain. The DApp incudes second commands for formatting the selected data to comply with the user defined criteria. The DApp incudes third commands for storing immutably the selected data in a new block of the blockchain. The DApp incudes fourth commands for allowing the smartphone to receive access criteria by which the smart contract operates to grant to other devices access to data immutably stored in the blockchain under conditions complying with the data access criteria.

### BACKGROUND

### Field of the Invention

The present invention relates generally to the field of data science. More particularly, the invention relates to blockchain technology. Even more particular, the invention relates to systems and methods for monitoring electronic transactions on a portable electronic device and automatically uploading transaction or usage data to a blockchain, wherein the permissions to the block chain are controlled by system and user constraints via a smart contract created by the smart app.

### Description of the Related Art

Personal computers, particularly smartphones and similar portable computing devices, are used for an astounding variety of activity involving information flow including social networking, information retrieval, weather predictions, fitness and exercise monitoring, personal health monitoring, timing, illumination source, photography, audio and video recording, voice and text communication, video and audio content streaming, gaming, emailing, calendaring, reminder lists, banking, tele-monitoring of home and office for security and operations control, reservations, purchasing of goods and services, remote control of equipment and automobiles, orientation and size measurement, device location, journaling, bar code reading, identification for accessing services and facilities and many, many other functions involving virtually all forms of activity.

Normal operation of such devices involve the generation of personal, user or usage data (simply called personal data hereafter), which has been (and continue to be) swept up (e.g., scraped from a browser, captured in a cookie, etc.) and stored by a large number of organizations including social media (e.g. FACEBOOK, YOUTUBE, WHATSAPP, FACEBOOK MESSENGER, INSTAGRAM, WEIXIN/WECHAT, TIKTOK, LINKEDIN, etc); on-line browsers (e.g. EXPLORER, GOOGLE CHROME, MOZILLA FIREFOX, APPLE'S SAFARI etc), on-line gaming (e.g. twitch.tv, roblox.com, app.link, chess.com, etc); and other activities including text messaging, e-mail, video on-line, shopping on-line e.g. AMAZON, financial services, audio streaming (e.g. music, podcasts, news etc.), communications with service providers, communications with employers, job searching, communicating with household equipment (e.g. Internet of Things (IoT)) etc.

Much of this personal data is recorded, stored and mined by online service providers and other third parties (sometimes with permission of the user, as a price for receiving the service/product desired by the user, or without the user's permission or knowledge). Some third parties, such as credit agencies (e.g. as EXPERIAN, TRANSUNION. EQUIFAX and others), are in collusive arrangements with service providers, lenders, financial institutions, and credit card companies who demand users' advance permission to allow access to and recording of this personal data in exchange for a variety of goods and services, to comply with governmental requirements (e.g. tax returns, driver's and professional licensing), and many other personal computer activities. Aggregation of this personal data by third parties creates an extremely valuable asset and may even form the core of certain business models such as the collection of personal information to allow for credit evaluations that may be beneficial to the end user but are part of a business model that often makes profits for such third parties.

In other instances, the personal data is swept up by third parties whose primary business model (e.g. GOOGLE and FACEBOOK) is based on acquiring the information and mining it for guidance in the selling of targeted advertising for enormous profits. These organizations and their shareholders are thus profiting on the aggregate personal data of billions of human beings.

The vast majority of Americans now own a cellphone of some kind. The share of Americans that own a smartphone is now 85%, up from just 35% in Pew Research Center's first survey of smartphone ownership conducted in 2011, https://www.pewresearch.org/internet/fact-sheet/mobile/ retrieved Jun. 25, 2021. According to one recent report, Americans check their mobile phones, on average, 262 times per day—that's once every 5.5 minutes, https://www.reviews.org/mobile/cell-phone-addiction/#:˜:text=You're%20not%20alone.,that's%20one%20every%205.5%20minutes, retrieved Jun. 25, 2021.

In addition to ubiquitous use of smartphones, more and more humans are acquiring additional personal computers particularly of the body mountable type generally referred to as wearables. These additional personal computers, which come in a variety of different forms and serve a vast array of purposes, including, for example, smartwatches, fashion accessories, fitness trackers, gaming devices, ear pods, and navigation tools. Unit sales for wearables are expected to be in the range of 400 million worldwide in 2021, https://arstechnica.com/gadgets/2021/05/more-people-are-buying-wearables-than-ever-before-and-apple-is-in-the-lead/, retrieved Jun. 26, 2021. Worldwide shipments for wearables are also expected to increase dramatically in the coming years, https://www.statista.com/statistics/610478/wearable-device-shipments-worldwide/Jun. 26, 2021. At the beginning of 2020, roughly one-in-five U.S. adults (21%) say they regularly wear a smart watch or body mountable fitness tracker, according to a Pew Research Center survey conducted Jun. 3-17, 2021, https://www.pewresearch.org/fact-tank/2020/01/09/about-one-in-five-americans-use-a-smart-watch-or-fitness-tracker/ retrieved Jun. 25, 2021.

Another measure of the depth and variety of functions performed by handheld and body mountable personal computers is the number of Apps that are available for downloading into personal computers such as smartphones and smartwatches. For example, the number of mobile apps available for use in smartphones has now reached many millions. As of November 2020, Apple's App Store was offering 4.3 million apps and games, while Google Play Store has 2.9 million, https://www.businessofapps.com/data/app-stores/, retrieved Sep. 23, 2021. The app economy built on these two platforms is estimated to be worth approximately $6.3 trillion according to App Annie, https://www.appannie.com/en/insights/market-data/app-economy-forecast-6-trillion-market-making/, Sep. 23, 2021.

Many of the uses of personal computers require the user to be authenticated such as by the use of passwords. U.S. Pat. No. 8,341,397, issued to the same inventor (Charles M. Leedom, Jr.) as the subject invention, discloses a security system and method for use in paired personal computer device(s) which eliminates (or greatly reduces) the need for relying on passwords to authenticate a user. U.S. Pat. No. 8,341,397 discloses automated passwordless authentication relying on paired personal computer device(s), held in close proximity, and is incorporated herein in its entirety. The '397 patent does not, however, provide a solution to other problems confronting individuals such as the maintenance of dominion over their own personal data since much of this data is swept up without the original owner's permission or with his permission obtained by mild (and sometimes not so mild) coercion. For example, the purchase of goods on-line almost always requires the user to provide personal information, including sensitive credit information, in exchange for goods or services which would otherwise be denied unless such personal information is provided.

Other passwordless systems for authentication rely on stored information such as face recognition or fingerprint information, which will almost always be susceptible to hacking or spoofing attacks because the newly scanned face or fingerprint image information will need to be compared to previously stored information. For example, early face recognition was easily fooled by a photograph of the user, https://www.tomsguide.com/us/phone-face-unlock-photo,news-28969.html#:⊇:text=The%20face%2Dunlock%20feature%20on,be%20fooled%20by%20a%20photograph. More sophisticated techniques can avoid this problem and other problems, such as using facial recognition on a sleeping person, but all such techniques can be spoofed once the techniques for avoiding failure become known because, as noted above, authentication relies on previously stored information. Accordingly, the stored “identifying” information can be swapped out and replaced with “fraudulent” information by a hacker.

Unauthorized uses of passwords are the root cause of over 80% of data breaches. To deal with this problem, industry organizations, such as the FIDO Alliance, have developed standards for authentication https://fidoalliance.org/what-is-fido/#:˜:text=FIDO%20Authentication%20is%20the%20Industry's,experiences%20across%20websites%20and%20apps, retrieved Jul. 28, 2021. FIDO Authentication is based on open standards. In particular, FIDO Authentication enables password-only logins to be replaced with secure and fast login experiences across websites and apps. The FIDO Alliance also claims that implementation of FIDO Authentication results in huge cost-savings through avoidance of password resets, device provisioning, and reduced customer support expenses and helps to implement a variety of authentication use cases, passwordless authentication, and multi-factor authentication to replace a security key, facial recognition, fingerprint, voice recognition and other authentication factors https://fidoalliance.org/what-is-fido/ retrieved Jun. 26, 2021.

The FIDO protocols use standard public key cryptography techniques to provide stronger authentication. During registration with an online service, the user's client device creates a new key pair. It retains the private key and registers the public key with the online service. Authentication is done by the client device proving possession of the private key to the service by signing a challenge. The client's private keys can be used only after they are unlocked locally on the device by the user. The local unlock is accomplished by a user—friendly and secure action such as swiping a finger, entering a PIN, speaking into a microphone, inserting a second—factor device or pressing a button.

The FIDO protocols are designed from the ground up to protect user privacy. The protocols do not provide information that can be used by different online services to collaborate and track a user across the services. Biometric information, if used, never leaves the user's device, https://fidoalliance.org/how-fido.works/ retrieved Jun. 26, 2021.

FIDO still allows each organization, which employs it, to accumulate personal data related to each end user with which the organization interacts. For example, internet browsers such as GOOGLE; social media such as FACEBOOK, TWITTER, etc.; individual merchants such as HOME DEPOT; medical service providers; and government organizations such as voter rolls, IRS and DMV etc. collect and store massive amounts of individual user data. Still other organizations, such as credit agencies like EXPERIAN, EQUIFAX AND TRANSUNION, sweep up personal financial transaction information under business models that, as noted above, collusively extort the personal information from end users who require credit to obtain goods or services. In some circumstances (such as medical emergencies) the user has no viable option to granting such permission for the credit agency to obtain and store such personal data. After being extorted/coerced into granting such permission, the credit agencies then use the data to supply, for profit, “credit ratings” to third parties from which the end user may wish to obtain goods or services in the future. Credit can be (and often is) withheld from any individual who does not agree to allow financial information to be shared with such credit agencies. Through this coercive process, the credit agencies come to possess extremely sensitive information that the credit agency then sells to other lenders and merchants from who the end user may wish (or desperately needs) to do business. After obtaining such personal data for profit making purposes, credit agencies have been notoriously lax in protecting the data from hackers with malign purposes. There have been millions of data breaches by hackers resulting in hundreds of billions of dollars lost to fraud.

As will be discussed in more detail below, blockchain technology possesses a number of interesting characteristics that provides tantalizing possibilities for disrupting traditional concepts for creating, storying, protecting, and controlling computer data. Blockchain has already disrupted the creation, storage, control and transfer of money by forming the backbone of cryptocurrencies such as Bitcoin. The key attributes of blockchain include immutability, transparency and decentralization. According to Imran Bashir, starting around 2013, there emerged a number of ideas for application of blockchain technologies outside of cryptocurrencies. See Bashir, Imran, Mastering Blockchain, Packt, Birmingham-Mumbai, Third Edition, 2020, at p. 4, the entire contents of which are incorporated herein by reference. In its most generic sense, a blockchain may be conceptualized as an “ever growing, secure, shared recordkeeping system in which each user of the data holds a copy of the records, which can be updated if all parties involved in a transaction agree to update,” supra, Bashir at p. 12.

Large financial service providers have disclosed systems for harnessing the benefits of blockchain technologies to the storage and retrieval of personal data such as disclosed in U.S. Patent Application Publication No. 2016/0342994 to Davis (MasterCard International Incorporated). Attempts have also been made to employ blockchains to store personal data for purposes designed to benefit the individual whose personal data is being captured in the blockchain. For example, U.S. Pat. No. 10,880,089 to Brown et al (NuID, Inc.) discloses a blockchain designed to record user identification and/or authentication information and to grant exclusive control over the information to the individual identified by the data. Still other attempts have been made to afford user control over his/her personal data by allowing the capture of personal information in a blockchain and allowing the user to grant access thereto to third parties via an authorized access data blockchain such as disclosed in U.S. Patent Application Publication No. 2019/0205563 to Gonzales, Jr. (eBay, Inc.).

These prior examples of blockchain used to store personal data do not provide the type of robust control that will allow a personal computer device to accept (1) user defined criteria for defining and changing the specific types of data generating events and the content of personal data resulting therefrom that may be captured in a personal blockchain, and (2) user defined terms of use under which the user's personal computer device(s) can grant to third parties access to such personal data on a changeable and revocable basis. No blockchain based system has been disclosed that includes features that allow robust enough control over individual users' personal data so as to return some portion of the value embodied in the vast amount of personal data being swept up by third parties under circumstances where the individual is either forced to grant permission or is unaware that his/her data is being recorded for the benefit of third parties.

Thus, there is a need for new and improved systems and methods for controlling data generated by personal computing devices.

### SUMMARY OF THE INVENTION

The subject invention solves the foregoing and other technical problems in the prior art by providing a smart App that resides on a portable personal computing device and controls capture of generated personal data. According to embodiments of the subject invention, a “smart contract” is created based on input of user constraints into a portable computing device and is stored in a blockchain. The smart app is configured to capture generated data according the smart contract and to store captured data in the blockchain. The smart contract is configured to control access to data in the blockchain. A smart contract is a term of art and the skilled person will understand that it does not refer to a legal instrument, but rather to an electronic construct such as a computer program in combination with data, configured to control certain aspects of the present invention.

According to embodiments of the invention, a user interface may be providing on a smart device which controls automatic updates to personal date associated with electronic transactions made using the smart device and the smart contract defines permissions to the block chain on a granular level.

According to embodiments of the invention, a smart contract can be associated with a plurality of devices and controlled centrally so that the default permissions are created that may be changed and some may not be changed on a per user basis. According to embodiments of the invention, system wide permissions may be provided controlled by a system administrative user and user specific permissions may be controlled by each individual user.

Embodiments of the subject invention are designed to return to users' personal computer devices broad and robust control over (and at least a portion of the value embodied in) the personal data created by each user's personal computers especially during each user's real time interactivity (i.e. access) with his/her personal computer devices such as a smartphone and a paired body mountable computer such as a smartwatch. In addition the subject invention would allow personal data generated automatically by the user's personal computer(s) such as geolocation data resulting from movement of the user to be recorded in the user's blockchain and made available to third parties (such as the user's cellular service carrier) only so long as the user wishes to allow such personal data to be accessed by the carrier. Among the many purposes, advantages, features and aspects of the subject invention are improved control, by a user's personal computer device(s), over the type and depth of personal data that may be created, identified, processed, and recorded in blocks of a personal blockchain such that each user's personal computer device(s) may exercise robust dominion over such data by controlling the extent and timing of third party access to the user's stored personal data.

Aspect of the subject invention provide a personal smart contract for interacting with the user's personal computer devices and associated personal blockchain in a manner to amplify the opportunities to generate and immutably store relevant personal data generated from the normal use of the smartphone as well as personal data generated by augmented uses facilitated by pairing two, or more, of a user's personal computer device(s). The average person accesses his/her smartphone a phenomenally high number of times every day estimated, as noted above, to be in excess of 250 times thereby creating many data generating opportunities each day. The personal smart contract of this invention amplifies these opportunities by relying upon and facilitating automated, secure pairing of the user's smartphone with a body mountable personal computer, such as a smartwatch, that can be more quickly and easily accessed than even a smartphone.

Other aspects of the invention include a method implemented by a decentralized application (DApp) formed by a smart contract and associated blockchain for managing personal data generated in real time by linked personal computers, including a smartphone and a body mountable computer, operating to perform functions executed/commanded at successive times as the user accesses the linked personal computers. The smart contract causes the linked personal computer devices to execute the steps of:

A. accepting user defined data criteria for the smart contract to use in selecting personal data, generated at successive times as the user accesses the linked personal computers for immutable storage in the blockchain;
B. formatting the personal data found by the smart contract to comply with the defined data criteria entered by the user;
C. storing immutably the selected personal data in a new block of the blockchain; and
D. accepting user defined access criteria by which the smart contract, operating within, or in association with, the user's personal computer(s) to grant to other persons access to data immutably stored in the blockchain under conditions complying with the user defined access criteria.

Each time the user's personal computer devices (such as smartphone and smartwatch) are accessed, an opportunity arises for the generation of personal data in real-time. For example, if a user accesses an AMAZON account for conducting a search for merchandise, the DApp (smart contract and blockchain) can be programmed to record such information as: date, time, search parameters, items purchased, amount paid, etc. This personal data can then be formatted and immutably stored in the next block of the associated personal blockchain. Similar types of information resulting from access of most other types of mobile apps running on the smartphone/smartwatch combination produce personal data including time, date, geolocation and other information associated with the user's access of the mobile app. The DApp (including smart contract and personal blockchain) includes program steps that allow the user to provide defined criteria by which personal data, resulting from user access of his smartphone and/or body mountable computer, can be evaluated and selected if, the smart contract determines that the defined criteria is satisfied. According to embodiments of the subject invention, various program steps forming the smart contract of this invention may be stored, wholly or in part, within the personal computer(s) of the user (as well as the personal computer(s) of other users) or may be stored in the cloud for execution outside of the user's personal computer device(s). Once selected, program steps of the smart contract and blockchain will cause portions of the personal data to be formatted and prepared for immutable storage in the next block of the blockchain. The smart contract and blockchain may be configured to also allow the user's personal computer device(s) to accept the access criteria by which the smart contract operates to grant to other persons access to data immutably stored in the blockchain under conditions complying with the user defined data access criteria accepted by the user's personal computer devices. The personal data generated in real time, while implementing a DApp, responds to successive time separated events involving data generated as a result of the function or functions being performed in real time by the body mountable personal computer and linked smartphone. The separated events are classifiable into categories describing different types of human activities such as financial events, taxable events, social networking events, security events, transportation events, accommodation events, and other events involving such things as health and fitness, entertainment, calendaring, gaming, tele-monitoring, location and other separately categorizable human activities. Each of the user defined criteria and the access criteria can include specific human activity categories or combinations of two or more activity categories.

By pairing a body mountable computer (such as a smartwatch) with the user's smartphone for example, as disclosed in U.S. Pat. No. 8,732,459 to Leedom (Syferex), the process of accessing the ever-increasing functionality of the modern smartphone can be not only simplified and executed in less time but expanded in scope by use of additional data gathering functions, such as biometric sensing, that is typically included on modern smart watches and other body mountable personal computers such as fitness tracking devices. In other words, the combination of paired personal computer devices with a specially adapted personal blockchain and personal smart contract, synergistically, facilitates and expands the automatic selection and immutable storage of personal data. The entire contents of U.S. Pat. No. 8,732,459 to Leedom are incorporate herein by reference.

The average person normally keeps his/her smartphone in the pocket of his/her clothing or in a backpack, purse, fanny pack or other mechanism for securing the phone within easy reach. When the user reaches for his phone or the phone emits a notification alert (by vibration and/or audible signal), the user will often engage in a series of motions required to locate and retrieve the phone. Assuming the phone has been stored in its usual place, the required motions may be minimally greater than the motion required to look at a wrist mounted smartwatch. But often the phone is either not in its normal location or the user is in a sitting position making retrieval of the phone from a back pocket or tight side pocket somewhat awkward. This phenomenon can sometimes become frantic when the phone emits an alert and is not in its usual location but resides remotely from the user (such as when the phone has been placed on a table or has fallen out of the owner's pocket). By providing a personal smart contract to interact, automatically, with a body mountable computer, such as a smartwatch, and a paired smartphone, a user can more easily select and immutably store his personal data in the personal blockchain that is associated with the paired personal computer devices.

Because an ever-increasing percentage of personal information is now being generated through the dramatically increasing functionality and usage of personal computers, and the increasing interactivity of human beings with their personal computers (primarily by use of their respective smartphones), this invention operates to create and monetize the enormously valuable information that is now being swept up by third parties, often through a variety of non-transparent, improper, and/or coercive methods.

Another aspect of this invention employs an electronic, distributed ledger, cryptographic platform for collecting, in real-time, and immutably recording, timestamped personal data captured from or generated by a person computing device, wherein selection of the data and/or access to the data remains at all times under the exclusive control of the user's personal computer device(s). More specifically, the invention employs a personal blockchain for immutably recording encrypted data that satisfies changeable user defined criteria accepted by the user's personal computer device(s). Access to the recorded data will remain under the exclusive control of the user's personal computer device(s) on a defined basis that may be altered at any time, to give either temporary or permanent (subject to revocation under certain conditions) access to third parties.

Another aspect of the invention is a smartphone for affording to its user's personal computer device(s) dominion over the personal data generated over time as the smartphone is accessed by the user while implementing (or operating in conjunction with) a DApp including a smart contract and blockchain wherein the personal data relates to successive time-separated events classifiable into categories describing different types of human activities. The decentralized application includes:
A. first commands (or steps) for allowing a user's smartphone, to accept user defined criteria for the smart contract to use in selecting personal data, generated at successive times as the user accesses the smartphone, for immutable storage in the blockchain;
B. second commands (or steps) for formatting the personal data found by the smart contract to comply with the defined criteria entered by the user and the blockchain's requirements for data to be stored in the blockchain;
C. third commands (or steps) for storing immutably the selected data in a new block of the blockchain; and
D. fourth commands (or steps) for allowing the user's smartphone to accept access criteria by which the smart contract operates to grant to other persons access to data immutably stored in the blockchain under conditions complying with the data access criteria accepted by the user's smartphone.

Still another aspect of this invention includes specialized, downloadable software DApp (decentralized application) appropriate for commercially popular, personal computer devices to provide automated authentication requiring no input of user credentials (passwords, usernames or bioscans) except during the initial mounting of the user's smartwatch on the user's wrist and initial activation of the user's smartphone, provided the user maintains control and proximity of his/her paired devices (e.g. paired smartphone and smartwatch). The subject invention improves on the invention disclosed in U.S. Patent Application Publication No. 2019/0349196 to Leedom, published Nov. 14, 2019, whereby user authentication can occur via the interface of either one of a pair of linked smartphone and smartwatch using encrypted data transmission. In particular, the subject invention capitalizes on the stunningly high number of times that smartphone owners access their handheld personal computer devices (e.g., smartphones), throughout each day via an improved authentication system involving the immutable storage of personal data in a personal blockchain that augments and improves on the authentication mechanism disclosed in the '196 publication. By allowing selected, time stamped personal data to be immutably stored by cooperative operation of the user's paired personal computer devices and associated personal smart contract and personal blockchain, an immutable record is created which, overtime, will allow for extremely reliable identification and authentication of the user and his/her personal data. By executing certain steps in the personal smart contract, the immutable personal data can be retrieved and used to provide authentication of the user and other valuable information, such as the user's credit worthiness, personal habits and other characteristics. This immutable personal data can be selectively made available to third parties by the user as he/she may desire in exchange for value, such as cryptocurrency supported by the blockchain, added to a personal account owned by the user. Particularly desirable blockchains are those that include tools for developing companion smart contracts such as e.g. Bitcoin, Ethereum, QTUM, Ethereum Classic, NEO (China's Ethereum), Card:Alio, EOS, etc. The entire contents of U.S. Patent Application Publication No. 2019/0349196 are hereby incorporated herein by reference.

An additional aspect of this invention includes a smart contract operatively associated with each user's blockchain (which may be a dedicated, personal blockchain or selective blocks in a larger blockchain containing other data and/or a combination of multiple linked blockchains, e.g., see U.S. Patent Application Publication No. 2019/0205563, supra, especially FIG. 1 and its description) wherein the smart contract takes the form of a computer program whose program steps create multiple layers including:
A. a core layer for implementing the users choices, accepted by the user's personal computer device(s), for selecting among the personal data derived from transactions (and other user activities and conditions) facilitated and sensed by a pair of personal computer devices, such as a smartphone and smartwatch, whereby only the personal data associated with the transactions/activities/conditions, in accordance with user defined criteria, are stored in the blocks of the personal blockchain;
B. a user device interfacing layer for creating (and standardizing) the input/output pathways between the user core and a user interface associated with either one (or both) of the paired personal computers to allow the user to receive information, respond to information and/or enter user commands including commands for defining criteria for selecting those personal data generating transactions and events that can be recorded in successive blocks of the associated personal blockchain and for selecting the content of the personal data that is descriptive of the transactions and/or events selected for storage in each block of the personal blockchain;
C. a personal computer interactive layer for providing (and standardizing) the manner of cooperation between and among the blockchain and the paired personal computer devices including cooperation in formatting the personal data that is stored and retrieved by the core layer; and
D. third party retrieval layer for defining (and standardizing) the manner by which personal data can be retrieved from the core layer such that
   a. the user's personal computer device(s) retains ultimate control over the personal data stored in his/her personal blockchain (or portions of one or more linked blockchains),
   b. third parties are limited to only certain types or categories of personal data,
   c. only portions of the stored data associated with the user that the third party is permitted to access,
   d. only certain uses of the retrieved data as a condition for access to the data,
   e. time limits on access, use and return (or destruction of) the retrieved data; and/or
   f. the user's personal computer device(s) is able to control the process by which consensus can be reached on the storage data and the degree to which miners may be rewarded for reaching consensus and the degree to which the reward for mining is shared with the user by, for example, digital value (such as cryptocurrency being automatically placed in the user's personal account.

Other layers, or sublayers within each layer, may be implemented by the program steps forming the personal smart contract of this invention.

The subject invention allows the personal computer device(s) of each individual user to control access to his/her respective personal data generated from operation of the user's personal computer device(s). Accordingly, the invention operates to restore to each individual's personal account a substantial portion of the value embodied in such data. The disclosed invention creates a user-centered, personal information ecosystem, employing blockchain technology including smart contracts and developmental tools associated therewith, for forming/modifying the user's blockchain(s), accumulating personal data and affording dominion to the user's device(s) over the user's personal data. Still more particularly, the disclosed user-centered ecosystem is designed to restore, a substantial portion of the enormous wealth embodied in aggregating information generated by those individuals who increasingly use their smartphones and/or other body mountable personal computers to facilitate virtually all aspects of their lives. As noted in the Background section, this information is now being swept up, stored (sometimes under dangerously vulnerable conditions) and used by third parties (such as social media platforms) to generate enormous profits which the subject invention will allow to be returned, at least in part, to the individual(s) personal accounts wherein the data is generated through personal computer use particularly through the use of paired personal computers such as a smartphone and a smartwatch.

According to embodiments, the subject invention provides one or more personal blockchains, and associated personal smart contracts, to acquire and immutably store personal data that can be aggregated in distributed ledgers formed by the blockchain(s) interacting with the smart contract(s) to empower the end user's personal computer device(s) to accomplish the following functions:
A. identify the types of operations of the user's personal computer device(s) that will generate data suitable to be immutably fixed in one or more blocks of the blockchain(s) and interactive smart contract associated with the individual,
B. select and format data identifying specific operations's of his/her personal computer which will allow the blockchain to record, as facilitated by the personal smart contract, a new block which will immutably store the data selected and formatted by the personal smart contract,
C. receive rewards in the form of government backed (fiat) currency or cryptocurrency (including a cryptocurrency created and supported by the personal blockchain) for deposit in a personal account belonging to and/or controlled by the user, and
D. allow nodes operating to support the personal blockchain to be rewarded via the same blockchain created cyptocurrency used to provide value to the personal account of the end user

Yet another aspect of this invention is the provision of a personal blockchain ecosystem that is built on an existing, publicly available, blockchain such as BITCOIN, ETHEREUM, HYPERLEDGER FABRIC, QUORUM, QTUM, ETHEREUM CLASSIC, NEO (CHINA'S ETHEREUM), CARDANO, EOS, etc., combined with associated developmental tools to allow for different personal blockchains, using different types of consensus algorithms.

Still another aspect of the invention involves executing the steps of the personal smart contract by two or more personal computer devices (wherein at least one or more are mountable on the user's body) whereby
A. the personal computer devices can be arranged to perform certain smart contract functions only when the personal computer devices are held in close proximity, and/or
B. selected smart contract functions are enabled only when the body mountable personal computer(s) (such as a smartwatch) are actually mounted on the user's body.

More specifically, the personal smart contract, designed in accordance with this invention, allows the end user's personal computer device(s) to receive specific criteria for determining those operations of the user's personal computer(s) that will generate and format data adapted to be recorded in successive blocks of the personal blockchain described herein. Examples of operations that will generate selected data for immutable recordation in the blocks of the personal blockchain are:
1. Social media interactions (e.g. Facebook, Twitter, Match.com etc),
2. On-line browsing (e.g. Explorer, Google Chrome, Mozilla Firefox, Apple's Safari etc),
3. Video viewing (e.g. YouTube and TikTok),
4. Communications (e.g. cellular phone operations, WhatsApp, etc.),
5. Messaging (e.g. Facebook Messenger, SMS etc),
6. Photo sharing (e.g. Instagram),
7. Multi-purpose messaging,
8. Electronic payments (e.g. PayPal, Venmo, Weixin/WeChat etc.),
9. Business networking (e.g. Linkedin, etc),On-line gaming (e.g. twitch.tv, roblox.com, app.link, chess.com, etc), and
10. Other activities including text messaging, e-mail, shopping on-line (e.g. Amazon), financial services, audio streaming (e.g. music and podcasts) news activities and their associated smart contract with blockchain(s) containing personal information generated by individual users of personal computers.

According to embodiments of the present invention, the personal smart contract of this invention allows third parties to access the personal data, immutably fixed in the blockchain, by operation of the smart contract responding to user defined criteria received by the user's personal computer device(s). The smart contract allows the user's personal computer device(s) to receive many types of limitations such as time limitations or conditions for use including conditions under which the data may be shared with third parties and/or returned to the original user (or destroyed) upon future conditions and/or misuse by the third party who has been granted conditional and/or temporary access to the personal data by the smart contract. Because the blockchain and associated smart contract may cause the data to be encrypted (e.g., using a locally generated public-private key pair), the personal smart contract may operate to grant access to selected third parties wherein such access is limited with respect to time, subject matter, specific blocks, and/or any other conditions that the smart contract and associated block chain is programmed to impose. This may be accomplished by PKI infrastructure that causes only the public key to be forwarded to third party users while the private key(s) are always retained in the user's personal computer device(s) and are never made available to third parties. PKI technology allows single use symmetric keys to be negotiated between the user and third parties for a variety of purposes such as the transfer of large volumes of data. The symmetric keys can be used for secure encrypted communication between the paired personal computers of users of this invention and third parties who are granted permission, on terms defined by the smart contract of this invention, to selected personal data immutably stored in the user's personal blockchain. Imran Bashir provides further explanation of the differences between symmetric cryptography and public key cryptography in Chapters 3 and 4 of his book, Mastering Blockchain, Third Edition, Packt Publishing, Birmingham 2020, the entire contents of which are hereby incorporated herein by reference

One aspect of the personal blockchain and associated smart contracts of this invention is the ability to impose fees (payable for example in digital assets, such as crypto currency created by the blockchain) for access to personal information stored in the blockchain. Such fees are creditable, at least in part, to a personal account of the user whose personal data is recorded in the blockchain. Programming the personal smart contract to operate with an existing blockchain that supports transfer of “digital assets” is an additional aspect of this invention because it will greatly simplify implementation and reduces costs and avoids involving a third party for clearing purposes as is required when a government backed currency is employed. The ability to transfer digital assets in a blockchain (known as “tokenization’) is explained in much greater detail in Chapter 18 of Bashir, Imran, Mastering Blockchain, supra, incorporated herein by reference.

The smart contract of this invention may be programmed to operate in association with any one of a number of different pre-existing blockchains offering tokenization such as BITCOIN (BTC), ETHEREUM (ETH), STELLAR (XLM), BINANCE COIN (BNB), CARDANO (ADA), DOGECOIN (DOGE), XRP (XRP) or other blockchains that presently exist or may be developed in the future. Each of these existing blockchains has advantages and disadvantages associated therewith including the programming language employed, the extent of development tools available to assist in the creation of a companion personal smart contract and the process by which consensus is reached among the various network nodes participating in adding additional blocks to the blockchain.

For example, the BITCOIN blockchain defines and enables transfer of Bitcoin cryptocurrency and is extremely well known and widely traded. However, the programming language (called Script) used for developing smart contracts using the BITCOIN blockchain is not Turing complete and can thus restrict smart contract programming. A programming language is Turing complete only when it can be used to simulate any Turing machine, i.e. is able to simulate all other data-manipulation rule sets. In this sense, BITCOIN's Script is not Turing complete. Moreover, BITCOIN blockchain uses a consensus algorithm known as Proof of Work which has proved to be essentially hackproof but extremely slow and energy inefficient as compared to other consensus algorithms.

ETHEREUM blockchain uses a Turing complete programming language and a faster consensus algorithm which is also more energy efficient than Bitcoin's Proof of Work consensus algorithm. ETHEREUM is in a transition to ETHEREUM 2.0 started by a “hard fork” which went live Aug. 5, 2021 that will eventually transition “ . . . the energy-intensive ‘proof-of-work’ mining system, where miners solve difficult math equations to create new coins, to ‘proof-of-stake’ which just requires users to leverage their existing cache of ether as a means to verify transactions and mint new tokens,” https://www.cnbc.com/2021/08/05/ethereum-just-activated-its-london-hard-fork-and-its-a-big-deal.html. Also, see Chapters 11-16 of Bashir, supra p. 311-524 for more information on how to implement a special purpose ETHEREUM blockchain. In particular, an extremely robust ecosystem of development tools has developed around ETHEREUM which is designed to facilitate programming of smart contracts. ETHEREUM also supports a number of different cryptocurrencies. These features of ETHEREUM makes it especially effective as a tool in implementing the subject invention.

It is another aspect of this invention to capitalize on the interactivity of users with their paired personal computers, to store immutably (and to retrieve the stored, immutable information captured in encrypted form) within blocks of a personal blockchain to form a valuable personal asset that can remain under the control of the individual user's personal computer device(s). In particular, the subject invention capitalizes on the reality that most individuals interact very frequently, each day, with one or more personal computers, particularly with at least one hand held device, such as a smartphone and/or a body mountable computer, including a smartwatch, fitness device, headphone, ear phones, ear rings, smart belts, head mountable devices such as glasses, headphones, other smart jewelry, e.g., rings, bands, desktop personal computers or any portal that allows a human to interact with a computer located proximally or at a distance via communication channels, wired and wireless.

An additional aspect of the subject invention is the use of encryption technologies for secure storage and retrieval of the user's personal data and for secure authentication and communication between and among the user's personal computer device(s). As is characteristic of blockchains, various network nodes hold duplicate copies of the personal blockchain containing the stored personal data. The data is subject to selective access by third parties who are granted permission by the user's personal computer device(s) thereby making the blockchain a permissioned blockchain. A more detailed aspect of this part of the subject invention is that encryption keys are created by the user's personal computer device(s) (e.g., the user's paired smartphone and smartwatch) such that the encryption keys can be used to encrypt the personal data (e.g. by encrypting each block of data stored in the user's blockchain). More particularly, user transactions, such as transactions successively enabled over time by the user's smartphone and/or paired smartwatch will generate user data that may be encrypted within blocks of the user's blockchain. The immutably stored personal data will be date stamped and stored in successive blocks of the associated personal blockchain. By creating and storing parts of each encryption key in the respective paired personal computers, the encryption of personal data for storage in the personal blockchain may be undertaken in a way that requires the respective paired personal computers to be in sufficient proximity for the DApp (smartcontract and blockchain) to operate properly. That is, for example, the paired personal computers must be brought into sufficient proximity for third party access to the stored personal data.

Still another more detailed aspect of the invention is that the paired personal computer device(s) includes a body mountable personal computer, such as a smartwatch, which must be initially activated such as by one or more of the following: entry of a password and/or bio metric signal resulting from the sensing of the user's face, fingerprints, pulse, or other unique characteristic of the user which may be reflective of the individual's unique DNA. This aspect of the subject invention will amplify the security of the personal smart contract and associated blockchain by permitting access to the user's data only when the user's body mountable computer, e.g., smartwatch, is actually attached to the user's body and initially activated as required. At all other times, even when in close proximity, the paired personal computers will not perform selected operations because the operating software requires the body mountable personal computer, such as a smartwatch to be mounted in operative position on the user and activated (e.g., via password and/or biometric test).

A more specific aspect is hardware components including at least two paired personal computers including, for example, a body mountable personal computer, such as a smart watch, and a handheld computer, such as a smartphone, which are in the possession of and under the control of the user. The operating systems within each device are designed to aid in authenticating the user including time variable encryption keys generated by each of the paired hardware components to allow secure encryption of the personal data arranged to be stored immutably in the associated personal blockchain or as blocks in a blockchain, serving other users and/or purposes, wherein only the user can enable the personal computer device(s) to grant access to those blocks containing the immutably stored personal data.

Still another aspect of the subject invention is that the blockchain containing personal stored data may operate to perform any one or combination of the following functions:

1. Immutably store selected personal data associated with the user, and
2. Store all information normally stored by a merchant of services or goods acquired by the user over time such that the merchant is granted access to the data subject to the following conditions
A. both the merchant and user wish to continue to do business, and
B. should either the merchant and/or user wish to terminate the on-going business relationship, the user would empower the user's personal computer device(s) to cut off all privileges the merchant has to access the transaction data except for limited purposes defined in the original engagement agreement. (This arrangement would allow the merchant to do business without having to assume the liability of storing personal information, such as credit card numbers, passwords etc. of its customers).

Yet another aspect of the subject invention is to reward the user by enabling the user's personal computer device(s) to make incremental payments using the associated smart contract and blockchain to compensate the user for agreeing to allow his/her personal data to be accessed by third parties. The amount of compensation can be modulated depending on the scope and content of permission given to the third party for access and use of the person data. The terms and operation of the smart contract designed in accordance with the subject invention performs one or more of the following functions:
1. define and control all aspects of third party access to the immutably stored personal data,
2. establish specific limitations on the type of personal data that can be accessed,
3. limit the time during which the personal data may be used,
4. control the ways in which the third party is allowed to use the personal data accessed,
5. define and enforce auditing procedures for detecting misuse of the accessed personal data,
6. detect misuse of personal data by third parties,
7. define and enforce penalties for misuse of the data,
8. set and collect charges in payment for granting access to third parties to the immutably stored data dependent on a) the data desired, b) the uses to which the third party will be allowed to make of the data accessed, c) the time period during which the data may be accessed, and d) the penalties that will be payable should any obligations be breached, and
9. other functions relating to how third parties are allowed access to and/or interact with the blockchain containing the user's personal data

The above-described subject matter may also be implemented as a computer-controlled apparatus, a computer process, a computing system, or as an article of manufacture such as a non-transitory computer-readable medium. These and various other features and aspects will be apparent from a reading of the following Detailed Description and a review of the associated Drawings.

This Summary is provided to introduce a selection of concepts in a simplified form that are further described below In the Detailed Description and is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The Detailed Description is described with reference to the accompanying figures.

FIG. 1 is an illustration of components of the subject invention wirelessly interconnected by alternative networks.

FIG. 2 is an illustration of the genesis block and successive blocks of the blockchain forming a component of the subject invention.

FIG. 3 is diagram of one block in the blockchain of the subject invention.

FIG. 4 is a chart illustrating the ecosystem including developmental tools for forming a blockchain in accordance with the subject invention using the Ethereum blockchain.

FIG. 5 is a diagram illustrating the organization of a DApp formed in accordance with the subject invention and the manner of data flow throughout the DApp.

FIG. 6 is a chart illustrating the various layers of a smart contract embodying the subject invention.

FIG. 7 is a chart illustrating the primary commands embodied in the program steps included in the smart contract of the subject invention.

FIG. 8 is a diagram illustrating the components of a smartphone suitable for implementing the subject invention.

FIG. 9 is a diagram illustrating the components of a smartwatch suitable to be wirelessly paired with the smartphone of FIG. 7 for implementing the subject invention.

### DETAILED DESCRIPTION OF THE PREFERRED EMBODIMENTS

The following Detailed Description describes a Decentralized Application DApp (which may be defined as any end-to-end decentralized blockchain application, including a user interface (usually a web interface), smart contract(s), and the host blockchain, See Chapters 11-14 of Bashir, supra, incorporated herein by reference) operable by (or in association with) a smartphone whereby the smartphone is empowered to accept user defined criteria for selecting the personal data that can be immutably stored in the blockchain and wherein the data is selected from among personal data generated overtime as a result of the smartphone being successively accessed by its user. In other aspects of the invention, the DApp operates to allow the smartphone to be paired with a body mountable personal computer, such as a smartwatch, to improve the ease, and reduce the time, during which the user may access the functionality of the smartphone thereby magnifying the amount of personal data that can be generated over time that satisfies the user's defined criteria. In still other aspects, the decentralized application includes layered software including a third party retrieval layer for defining (and standardizing) the manner by which personal data can be retrieved from a core layer such that
A. the user's personal computer device(s) retains ultimate control, in accordance with the user's defined criteria, over the personal data stored in the user's personal blockchain (or portions of one or more linked blockchains);
B. third parties are limited to
   i. only certain types or categories of personal data,
   ii. only portions of the stored data associated with the user that the third party is permitted to access,
   iii. only certain uses of the retrieved data as a condition for access to the data, and/or,
   iv. time limits on access, use and return (or destruction of) the retrieved data; and/or;
C. the user's personal computer device(s) is able to control the process by which consensus can be reached on the stored data and the degree to which miners may be rewarded for reaching consensus and the degree to which the user shares the reward of mining by having digital value (for example in the form of cryptocurrency) deposited in the user's account.

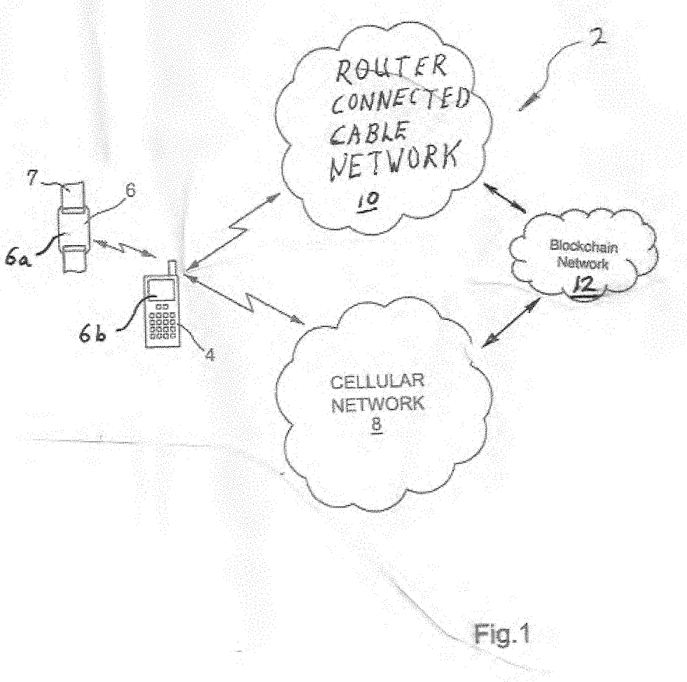

FIG. 1 illustrates, at a high level of abstraction, elements of a combination 2 implementing the subject invention. In particular, a handheld personal computer, such as a smartphone 4 (e.g. Apple iPhone or Galaxy smartphone), is illustrated as wirelessly linked to a body mountable personal computer, such as a smartwatch 6 (e.g. Apple Watch or Galaxy Watch) in a manner described in the commonly assigned '196 Publication to Leedom, cited above, the disclosure of which has already been incorporated by reference. Smartwatch 6 may be equipped with a wrist band 7 or other mechanism by which the smartwatch 6 may be mounted on the wrist (or other body part) of the user. The linked smartphone 4 and smartwatch 6 implement an authentication algorithm by use of encryption keys generated in the respective, smartphone 4 and smartwatch 6 as disclosed in the '196 Publication to Leedom (provided the personal computers are maintained in close proximity). The personal computers illustrated in FIG. 1 are wirelessly linked to each other, using for example Bluetooth wireless transmitters, to facilitate the running of apps that interact with the user via the interface of either one (or both) of the personal computers. For example, an ever increasing number of mobile apps are adapted to be operated either from the touch screen of the smartwatch or the touch screen of the linked wrist mounted smartwatch (e.g. iPhone and Apple Watch or Galaxy smartphone and linked Galaxy Watch). The linkage of smartphone 4 with smartwatch 6 allows the user to access the functionality of most of the apps implemented by his/her smartphone with improved ease, and reduced time. In particular, a user's smartphone is often stored in the pocket of his/her clothing or purse, backpack, fanny pack or other carrying implement resulting in the need for retrieval from such stored position whenever the user desires to access the functionality of the smartphone 4. If the smartphone is actually stored where the user believes it to be, retrieval may only require a short time. But often the smartphone 4 will have been stored elsewhere (or mislaid on an adjacent support surface or even temporarily lost such as by having fallen out of its stored location). Having a linked, body mountable personal computer, such as a smartwatch 6 linked to access functionally the apps running in the user's smartphone 4, will often allow the user to secure the benefits of the many apps running on his smartphone without having to retrieve the smartphone from its stored (or actual misplaced or difficult to locate) position. As will be explained further below, the benefits of the subject invention are magnified when implemented by wirelessly linked smartphone 4 and paired smartwatch 6.

The subject invention capitalizes on the stunningly high number of times that smartphone owners access their handheld personal computer devices (e.g. smartphones), throughout each day, now estimated to be over 250 times. The subject invention improves on the authentication mechanism disclosed in the '196 Publication to Leedom by, among other things, adding a DApp (including a blockchain and smart contract) which selects personal data generated as the user accesses his smartphone 4 at successive times throughout each day. More particularly, the subject invention allows the user to enter user defined criteria which defines the type and exact content of personal data that is to be selected by the DApp. By taking advantage of the successive generation of personal data (brought about by the very large number of times the average user accesses his smartphone 4) and by combining such personal data with time and/or geolocation information, the personal data that satisfies the user defined criteria can be formatted and immutably stored for later retrieval by third parties, if and only if the user's personal computer device(s) grants permission to those third parties.

Personal data subject to immutable storage in a blockchain in accordance with this invention could also result from background operation of the user's personal computers. For example, as the user moves about, his smartphone will periodically update the user's location which is now recorded by the user's cellular service provider. Such information could be stored in the user's blockchain and made available to the cellular service provided on a need to know (but revocable) basis. By operation of the subject invention, the user would have ultimate control over this geolocation information.

The personal data now collected websites accessed by apps downloaded and operated on the user's personal computer could be stored in the user's blockchain and made available to such websites on a permissioned basis. This would allow the user to revoke access to this information by the websites at any time.

By allowing selected, time stamped (and/or geolocation stamped) personal data to be immutably stored in this manner, an immutable record will be created which, overtime, will allow for extremely reliable identification and authentication of the user and his/her personal data. By executing certain steps in the personal smart contract, the immutable personal data can be retrieved and used to provide authentication of the user and facilitate a variety of third party functions, such as allowing the user's credit worthiness to be assessed and his personal habits and activities to be analyzed for targeted advertising and other purposes. This immutable personal data will remain, at all times, under the ultimate control of the user's personal computer device(s) and can be selectively made available to third parties by the user's personal computer device(s) but only under conditions enforced by the smart contract, based on user defined criteria received by the DApp (including smart contract and blockchain) with which third parties must agree to be bound as a condition for the smart contract to grant access to the personal data.

A further condition of the smart contact may be to require third parties to agree to advance some type of value such as fiat currency or “digital value” in exchange for the privilege of accessing the personal data. One example of the “digital value” that could be advanced would be cryptocurrency supported by the blockchain e.g. BITCOIN, ETHEREUM, DOGCOIN, QUORUM, QTUM, ETHEREUM CLASSIC, NEO (CHINA'S ETHEREUM), CARDANO, EOS, etc all as described in more detail below.

These benefits are amplified when the user's smartphone 4 is linked with a body mounted computer, such as a smartwatch 6, because of the added ease and reduced time required for accessing the full functionality of the user's smartphone 4. In particular, the subject invention enables a smartphone to receive user defined criteria for selecting personal data generated by operation of the smartphone 4 for its various intended purposes (such as voice communication) and/or as a result of running any one or more of the downloaded apps on the user's smartphone 4 as described above.

Referring again to FIG. 1, the user's smartphone 4 (and smartwatch 6 which may be equipped with its own cellular transceiver, in addition to the cellular transceiver in the smartphone 4) will inherently generate personal data when performing its many functions. This data can be selected and formatted for wireless transmission (via cellular network 8 or router connected cable network 10) to a blockchain duplicated in full in each of a plurality of nodes (e.g. plural, physically dispersed, interconnected servers) that collectively form a blockchain network 12.

As noted in the Summary, blockchains possesses a number of characteristics that are disrupting traditional notions regarding how computer data can be created, stored, protected and controlled. Blockchains have already disrupted how humans generally think about the creation, storage, control and transfer of money by forming the backbone of cryptocurrencies such as Bitcoin. The key attributes of a blockchain are immutability, transparency and decentralization. According to Imran Bashir, starting around 2013, there emerged a number of ideas for application of blockchain technologies outside of cryptocurrencies. See Bashir, Imran, Mastering Blockchain, Packt, Birmingham-Mumbai, Third Edition, 2020, at p. 4, the entire contents of which are incorporated herein by reference. In its most generic sense, a blockchain may be conceptualized as an “ever growing, secure, shared recordkeeping system in which each user of the data holds a copy of the records, which can be updated if all parties involved in a transaction agree to update,” supra, Bashir at p. 12. A more technical definition of a blockchain is “a peer-to-peer, distributed ledger that is cryptographically secure, append-only, immutable (extremely hard to change), and updateable only via consensus or agreement among peers,” Bashir, supra at p. 12. For purposes of this disclosure, the terms used in this technical definition will have the following meaning:

### Peer-to-Peer

This means that there is no central controller in the network, and all participants (nodes) directly communicate to each other. This property allows for transactions to be conducted directly among the peers without third-party involvement such as by a bank server.

### Distributed Ledger

A “ledger” is distributed when the electronic ledger is spread across the network among all peers (nodes) in the network, and each peer stores an electronic copy of the complete ledger.

### Cryptographically Secure

The ledger is cryptographically secure when cryptography has been used to provide security services that makes the ledger secure against tampering and misuse. In particular, the cryptography employed needs to provide non-repudiation, data integrity, and data origin authentication which may be achieved by state-of-the-art public key cryptography which is explained in great detail in Chapter 4 of Bashir, supra, incorporated herein by reference.

### Append Only

A blockchain is “append only” when data can only be added to the blockchain in time-sequential order, which means that once data is added to the blockchain, it is almost impossible to change that data and it can be considered practically immutable to form a tamper-proof ledger of transactions. In rare instances, collusion against the blockchain network by bad actors succeeds in gaining more than 51 percent of the power. Bashir explains how data may be changed in a blockchain but for all practical purposes, the data held in a blockchain may be considered immutable.

### Updatable Via Consensus

This is a very important attribute of a blockchain and refers to the fact that no central authority is in control of updating the ledger. Instead, any update made to the blockchain is validated against strict criteria defined by the blockchain protocol and added to the blockchain only after a consensus has been reached among all participating peers/nodes on the network. To achieve consensus, there are various consensus facilitation algorithms that ensure all parties agree on the final state of the data on the blockchain network and resolutely agree upon it to be true. A variety of known consensus algorithms (such as CPU-bound Proof of Work, Memory-bound Proof of Work, Committee-based Proof of Stake, Chain-based Proof of Stake, etc.) are discussed in Chapter 5 of Bashir, supra which is incorporated herein by reference.

An element in securing the full potential of blockchain technology is the idea of a “smart contract” which can be defined as a “secure and unstoppable computer program representing an agreement that is automatically executable and enforceable.” Bashir, supra at p. 290. Bashir further explains that
“ . . . a smart contract is, fundamentally, a computer program that is written in a language that a computer or target machine can understand. It encompasses agreements between parties in the form of business logic. Another fundamental idea is that smart contracts are automatically executed according to the instruction that is coded in, for example, when certain conditions satisfy. They are enforceable, which means that all contractual terms perform as specified and expected, even in the presence of adversaries.” Bashir, supra at p. 290.

In summary, a smart contract as the term is used in this disclosure has the following properties

Automatically executable: It is self-executable on a blockchain without requiring any intervention.
Enforceable: This means that all contract conditions are enforced automatically.
Secure: This means that smart contracts are tamper-proof (or tamper-resistant) and run with security guarantees. The underlying blockchain usually provides these security guarantees; however, the smart contract programing language and the smart contract code must be correct, valid, and verified.
Deterministic: The deterministic feature ensures that smart contracts always produce the same output for a specific input. Even though it can be considered to be part of the secure property, defining it here separately ensures that the deterministic property is considered one of the important properties.
Semantically sound: This means that they are complete and meaningful to both people and computers.
Unstoppable: This means that adversaries or unfavorable conditions cannot negatively affect the execution of a smart contract. When the smart contracts execute, they complete their performance deterministically in a finite amount of time. Bashir, supra at p. 293.

Further characteristics of smart contracts are discussed in Chapter 10 of Bashir, supra, incorporated by reference herein.

Smart contracts may be employed without using a blockchain. However, Bashir states that “blockchain platforms play a vital role in providing the necessary underlying network with security guarantees required to run the smart contracts,” Bashir, supra at p. 291.

ETHEREUM is a blockchain developed by Dr. Gavin Wood and is disclosed in his Ethereum yellow paper, https://ethereum.github.io/yellowpaper/paper.pdf. ETHEREUM is designed to provide a mechanism for developing blockchain applications for virtually any purpose. For this reason, ETHEREUM employs a Turing-complete programming language that allows the development of arbitrary programs (smart contracts) for blockchain and Decentralized Applications (DApps). In addition to the current ETHEREUM Mainnet which is the current live network of ETHEREUM there are a number of Testnets that enable a testing environment for newly developed blockchains and DApps. In addition, it is possible to create private networks by generating a new genesis block such as when a private group of entities start a new blockchain network and use it as a permissioned or consortium blockchain, Bashir, supra p. 318. Chapters 13 and 14 of Bashir describe the Ethereum development environment with special emphasis on the tools and frameworks for ETHEREUM smart contract development using Solidity programing language which is the most popular development language for smart contracts on ETHEREUM

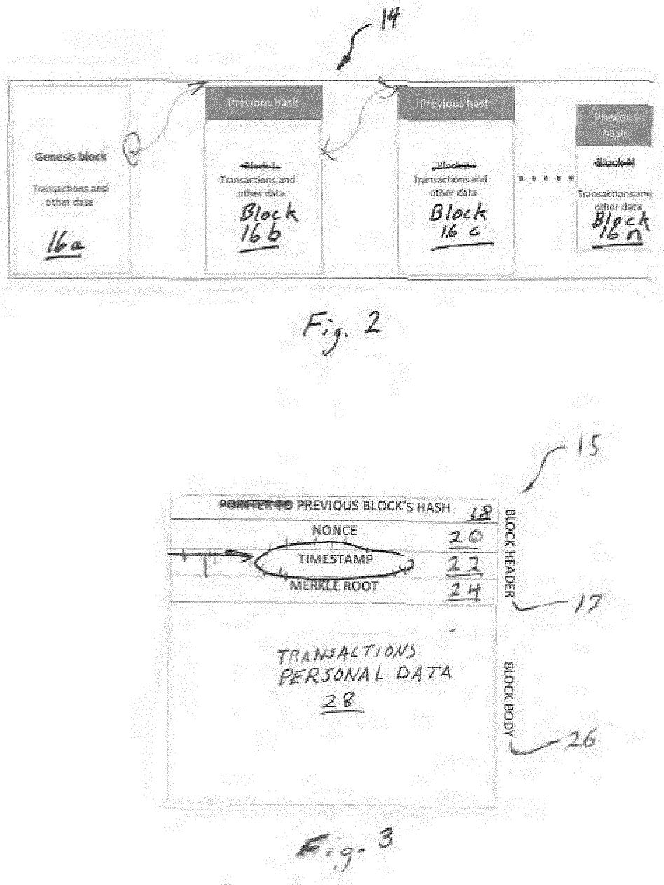

Reference is now made to FIGS. 2-4 which illustrate how a Decentralized Application (DApp) including specifically a specially designed smart contract and an associated blockchain can be developed and used to implement the subject invention. In particular, FIG. 2 illustrates a blockchain 14, on the most fundamental level, as a series of successive blocks 16a- 16n with the first block 16a being the genesis block containing transaction data and other data relevant to the purposes of the blockchain 14 which, for purposes of this invention, will be to form a personal blockchain for receiving personal data generated from the operation of one or more personal computers wherein the actual data selected must satisfy user defined criteria referenced above and described in more detail below.

The second block 16b is formed from a “hash” of the previous block (the genesis block 16a) plus additional data which in the present invention will include personal data selected from one or more data generating events prompted by a user accessing his/her smartphone 4 (and accompanying body mountable computer, such as smart watch 6) thereby causing a smart contract designed in accordance with this invention to be activated. A hash results from a function that takes an input text of any length and produces an output which is a fixed-length compressed version of the input. Hash functions suitable for use in a blockchain are discussed at great length in Chapter 4 of Bashir, supra. The next block 16c will include a hash of block 16b plus additional data including personal data generated by the associated smartphone 4, selected in accordance with the user defined criteria and formatted in accordance with operations defined by the associated smart contract and blockchain (collectively forming a DApp-decentralized application). Each successive block 16n will be formed in the same manner whereby the successive blocks of blockchain 14 create immutable stored records containing immutable person data associated with data sets created during successive time intervals (each of which may be separated in time) including personal data generated by paired personal computers such as paired smartphone 4 and smartwatch 6 of FIG. 1) accessed during the corresponding time intervals.

Immutability of the data derives from the use of encryption techniques suitable for use in blockchains as discussed at length in Chapters 3 and 4 of Bashir, supra. A typical block 15 in a blockchain formed in accordance with this invention is illustrated in FIG. 3. In particular this generic block 15 includes a block header 17 which is formed of a previous block's hash 18, a nonce 20, a timestamp 22, and a Merkle root 24. The nonce 20 is a number that is generated and used only once. A nonce is used extensively in many cryptographic operations to provide replay protection, authentication, and encryption. In blockchains, a nonce is used in PoW consensus algorithms and for transaction replay protection. Block 15 includes the nonce value. A timestamp 22 is the creation time of the block. A Merkle root 24 is a hash of all of the nodes of a Merkle tree. In a blockchain block, it is the combined hash of the transaction data (discussed below) in the block. Merkle trees are widely used to validate large data structures securely and efficiently. The Merkle root 24 in the block header 17 of block 15 is the hash of all transactions including the personal data 28 forming the block body 26. This means that verifying only the Merkle root is required to verify all transactions present in the Merkle tree instead of verifying all transactions one by one. This concept is described in greater detail in Chapter 4 of Bashir, supra.

As noted above, block 15 includes a block body 26 including transactions 28. A transaction is a record of an event which in the present invention includes personal data derived from one or more accessing events by the user of his personal computers whereby personal data is generated and is selected if the personal data satisfies user defined criteria previously received by the user's personal computer device(s) as will be explained herein below.

Each node of the blockchain network 12 performs functions assigned to it by the blockchain 14 including the implementation of a consensus protocol, simple payment verification, validation and many other functions depending on the type of blockchain used and the role assigned to the node. For example, nodes may perform a transaction signing function. Transactions are first processed by nodes and then also digitally signed by nodes using private keys as proof that they are the legitimate owner of the asset that they wish to transfer to someone else on the blockchain network (otherwise known as a wallet function). This asset may be a token or virtual currency, such as BITCOIN or ETHER (the cryptocurrency supported by ETHEREUM), but it can be any real-world asset represented on the blockchain by using tokens. One aspect of the present invention is to program the blockchain to reach consensus via Proof of Work, Proof of Stake, Delegated Proof of Stake or one of many other consensus algorithms discussed on pages 30-33 of Bashir, supra. In addition to reaching consensus, the blockchain will reward nodes for implementing the consensus algorithm by transferring something of value such as cryptocurrency, fiat currency or other token representing value to the node (and its operator).

Because ETHEREUM (including ETHEREUM 2.0) uses a Turing complete programming language and a faster consensus algorithm (called Proof of Stake) which is also more energy efficient, the present invention can be more easily implemented using the ETHEREUM blockchain (described in Chapters 11-12 of Bashir, supra) using the developmental tools described in Chapters 13-15, Bashir, supra. Future implementations of the subject invention may employ a World Computer as described in Chapter 16 of Bashir which describes ETHEREUM 2.0 projected for full launch in 2022. FIG. 4 presents a description of the components of the ETHEREUM development ecosystem 30 as discussed in more detail in Chapter 14 of Bashir, supra, especially p. 432. For example, FIG. 4 lists programming languages that facilitate creation of smart contracts operating on the ETHEREUM blockchain. Solidity 32 is most commonly used for contract writing for ETHEREUM. VYPER 34 is a Python-like experimental language that is being developed to bring security, simplicity, and auditability to smart contract development. Compilers 36 are used to convert high-level contract source code into the format that the ETHEREUM execution environment understands. The remaining components of the ETHEREUM development ecosystem is described in detail by Bashir starting at page 433.

Regardless of what blockchain and developmental ecosystem is used, the subject invention may include, as one aspect in certain applications, a mechanism and method for awarding value to

1. nodes for implementing the consensus algorithm by transferring something of value such as cryptocurrency, fiat currency or other token representing value to the node (and its operator) in an mount controlled by the process described above as “mining”, and
2. each end user in compensation for granting access to that end user's personal data stored immutably in blocks of the blockchain for which the user has private keys but for which the associated smart contract can award limited access to third parties as discussed above and described in more detail below.

In particular, FIG. 5 illustrates a DApp 32 designed in accordance with this invention including a blockchain 34 and smart contract 36 functioning to (1) allow control by the user's personal computer device(s) over the type and content of personal data stored in blockchain 34 and (2) allow control by the user's personal computer device(s) over third party access to the user's personal data via smart contract 36. Chapters 12 and 13 of Bashir, supra, describe in detail the general concepts and relevant tools useful in creating and deploying the smart contract 36 for implementing the subject invention. Referring to FIG. 5, the smart contract 36 is arranged to receive user inputs 38 including user defined data criteria 40 for the smart contract to use in selecting personal data, generated at successive times as the user accesses the linked personal computers, for immutable storage of selected personal data in the blockchain 34. Smart contract 36 formats the personal data found by the smart contract to comply with the defined criteria received from the user. The smart contract causes the formatted data 42 to be transferred to the blockchain 34 as will be described in further detail below. Based on the algorithmic steps implemented by blockchain 34, the formatted data is embedded, in encrypted form, into the next block of blockchain 34 whereby the personal data becomes immutably fixed. As part of the immutable fixation process, the proposed block is subjected to the consensus algorithm employed by the blockchain and implemented by plural nodes on the blockchain network. In the case of Ethereum, the consensus algorithm is presently a Proof of Work which will be transitioned to a Proof of Stake under Ethereum 2.0. To incentivize the nodes to perform the consensus algorithm, a tokenized value is transferred to the respective node, e.g. a node's account 44, which in the case of Ethereum can be a specific amount of ether cryptocurrency.

User inputs 38 for smart contract 36 also include the user of a linked pair of personal computers (e.g. smartphone 4 and smartwatch 6) to enter user defined access criteria 46 by which the smart contract operates to grant, to third parties, access to data immutably stored in the blockchain 34 under conditions complying with the data access criteria 46 received from the user.

Each time one of the user's personal computer devices (such as smartphone 4 or smartwatch 6) is accessed, an opportunity arises for the generation of personal data in real time. For example, if the user accesses an Amazon account for conducting a search for merchandise, the DApp 32 (including smart contract 36 and blockchain 34) will record selected personal data 39 complying with the user defined data access criteria 40 including such information as: date, time, search parameters, items purchased, amount paid, etc This personal data can then be formatted and immutably stored in the next block of the associated personal blockchain 34. Similar types of information resulting from access of most other types of mobile apps running on the smartphone/smartwatch combination produce personal data including time, date, geolocation and other information associated with the user's access of the mobile app. The personal data 39 generated in real time, while operating DApp 32, responds to successive time separated events involving data generated as a result of the function or functions being performed in real time by the paired smartphone 4 and smartwatch 6. The personal data 39 generated in separated events are classifiable into categories describing different types of human activities such as financial events, taxable events, social networking events, security events, transportation events, accommodation events, and other events involving such things as health and fitness, entertainment, calendaring, gaming, tele-monitoring, location and other separately categorizable human activities. Each of the user defined data criteria 40 and the user defined access criteria can fall within specific human activity categories or combinations of two or more activity categories.

The amount of value granted for “mining” will be determined by the rules imposed by the blockchain 34 and will be set to induce adequate computing resources to implement the consensus algorithm and add additional blocks to the blockchain 34. The amount of value granted to each end user can be controlled and modulated by the programming steps contained in the smart contract 36 associated with the blockchain 34. The amount of value granted to each user can be varied in accordance with market forces which the smart contract is designed to harness. More particularly, as will be explained in greater detail herein below, the smart contact 36 of the present invention operates to provide access to the personal data immutably stored in the associated blockchain 34 of each user who agrees to have his/her personal data stored in their respective blocks of blockchain 34. While a single blockchain 34 serving all users could be constructed, efficiencies may derive from subdividing the users into smaller groups served by a sub-blockchain. Alternatively, the subject invention could be practiced by providing each user with his/her own personal blockchain 34.

Access to this personal data in blockchain 34 may be controlled on a user-by-user basis as determined by the user defined access criteria 46 received by the personal computer device(s) of each user. Access to the personal data of all users (of the DApp 32 of this invention including blockchain 34 and smart contract 36) can be offered to third parties in exchange for payment in accordance with a fee schedule organized to maximize revenue on behalf of the users. This functional step is illustrated in FIG. 5 by an arrow connecting blockchain 34 with user accounts 50. In other words, by aggregating access to personal data of all users of the subject invention, compensation can be afforded to the users for access to their personal data based on the amount that third parties are willing to pay for such access. The fees paid to individual users can be set at a minimum level sufficient to induce users to adopt the DApp 32.

Control over the design and operation of DApp 32 can be the responsibility of an association whose membership is made up of all individual users of DApp 32. The rules imposed by the terms of the smart contact 36 will essentially be self-enforcing with resort to legal enforcement by the association of users reserved for only the worst offenders. Denial of future access should induce compliance with the rules by most third parties desiring access to the aggregated, immutable stored personal data of all members of the association of users.

As noted in Chapter 13 of Bashir, supra, the DApp 32 can be set up to operate on either a private network or a public network such as ETHEREUM Mainnet. To assist in developing the smart contract 36 for implementing the subject invention, developmental tools and frameworks, like Truffle and Ganache can be employed as described in more detail in Chapter 14 of Bashir, supra.

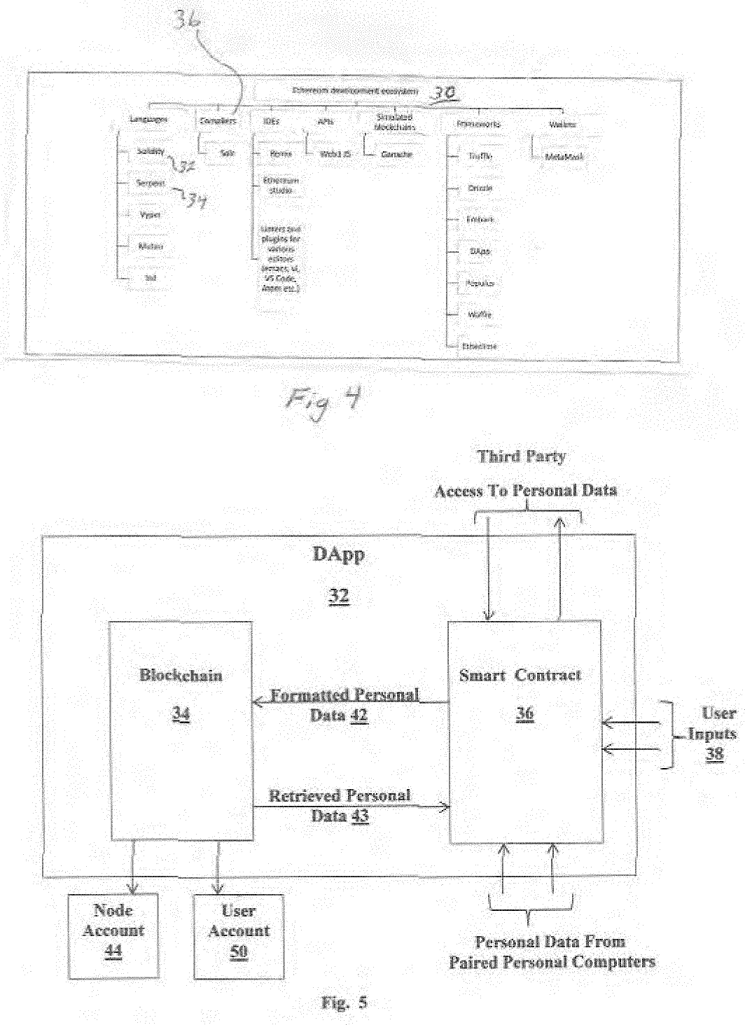

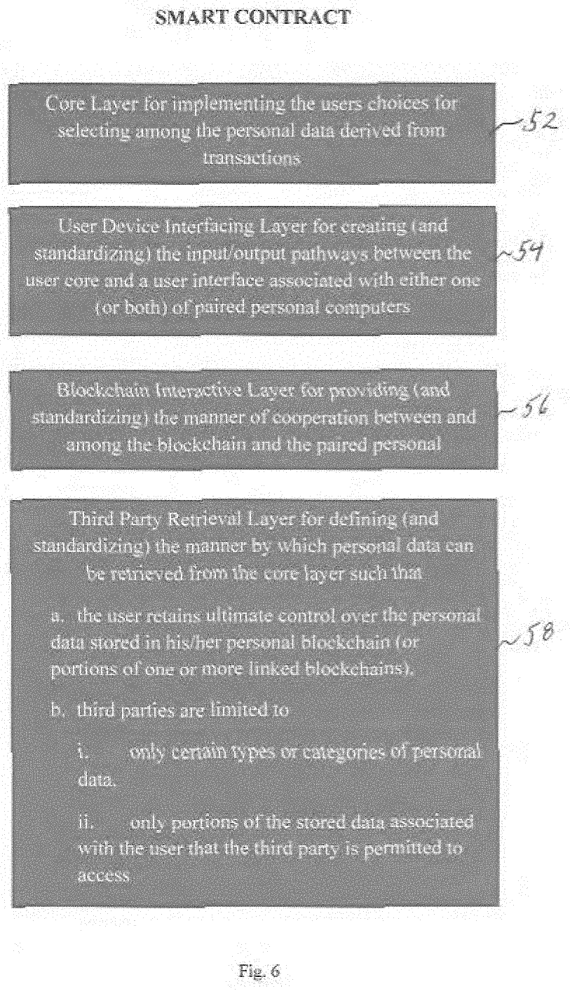

Reference is now made to FIG. 6 which depicts the smart contract 36 of FIG. 5 in the form of a computer program whose program steps create multiple layers including

1. A core layer 52 for receiving and implementing the users choices for selecting among the personal data derived from transactions (and other user activities and conditions) facilitated and sensed by a pair of personal computers, such as a smartphone and smartwatch, whereby only the personal data associated with the transactions/activities/conditions, satisfying the user defined criteria received by the DApp 32, are stored in the blocks of the personal blockchain;
2. A user device interfacing layer 54 for creating (and standardizing) the input/output pathways between the user core and a user interface associated with either one (or both) of the paired personal computer device(s) to allow the user's devices to receive information, respond to information and/or receive user commands including commands for defining criteria for selecting those personal data generating transactions and events that can be recorded in successive blocks of the associated personal blockchain and for selecting the content of the personal data that is descriptive of the transactions and/or events selected for storage in each block of the personal blockchain;
3. A personal computer interactive layer 56 for providing (and standardizing) the manner of cooperation between and among the blockchain and the paired personal computer devices including cooperation in formatting the personal data that is stored and retrieved by the core layer; and
4. A third party retrieval layer 58 for defining (and standardizing) the manner by which personal data can be retrieved from the core layer such that
A. the user’ personal computer device(s) retains ultimate control over the personal data stored in the user's personal blockchain (or portions of one or more linked blockchains),
B. third parties are limited to
   i. only certain types or categories of personal data,
   ii. only portions of the stored data associated with the user that the third party is permitted to access,
   iii. only certain uses of the retrieved data as a condition for access to the data, and/or
   iv. time limits on access, use and return (or destruction of) the retrieved data; and/or
C. the user is able to control the process by which consensus can be reached on the storage data and the degree to which miners may be rewarded for reaching consensus and the degree to which the user's account receives a portion of the reward for mining.

Other layers, or sublayers within each layer, may be implemented by the program steps forming the personal smart contract of this invention. Smart contract 36 may be operatively associated with each user's blockchain which may be a dedicated, personal blockchain or selective blocks in a larger blockchain containing other data and/or a combination of multiple linked blockchains.

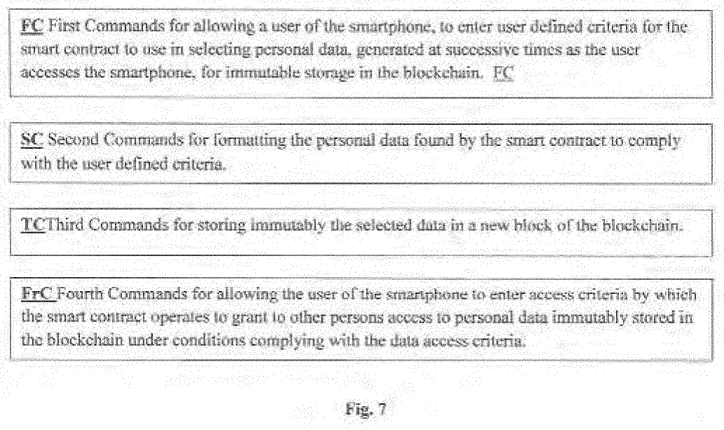

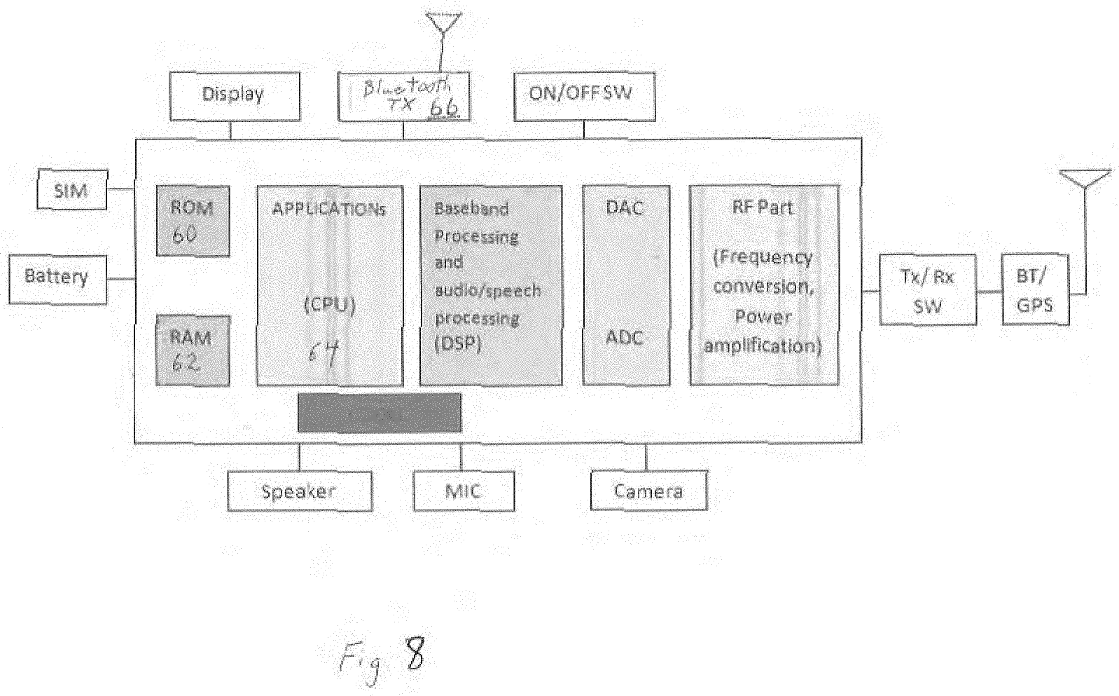

The smart contract 36 preferably includes sequential command steps which may be subcategorized as illustrated in FIG. 7. In particular, smart contract 36 includes first commands FC for allowing a user's smartphone, to receive user defined criteria for the smart contract to use in selecting personal data, generated at successive times as the user accesses the smartphone, for immutable storage in the blockchain. Second commands SC are included for formatting the personal data found by the smart contract to comply with the received user defined criteria.

The smart contract 36 also includes third commands TC for storing immutably the selected data in a new block of the blockchain. Finally, fourth commands FC are included for allowing the user's smartphone to receive access criteria by which the smart contract operates to grant to other persons, such as interested third parties who are willing to comply with the conditions and fees imposed by the smart contract 36, access to personal data immutably stored in the blockchain under conditions complying with the data access criteria.

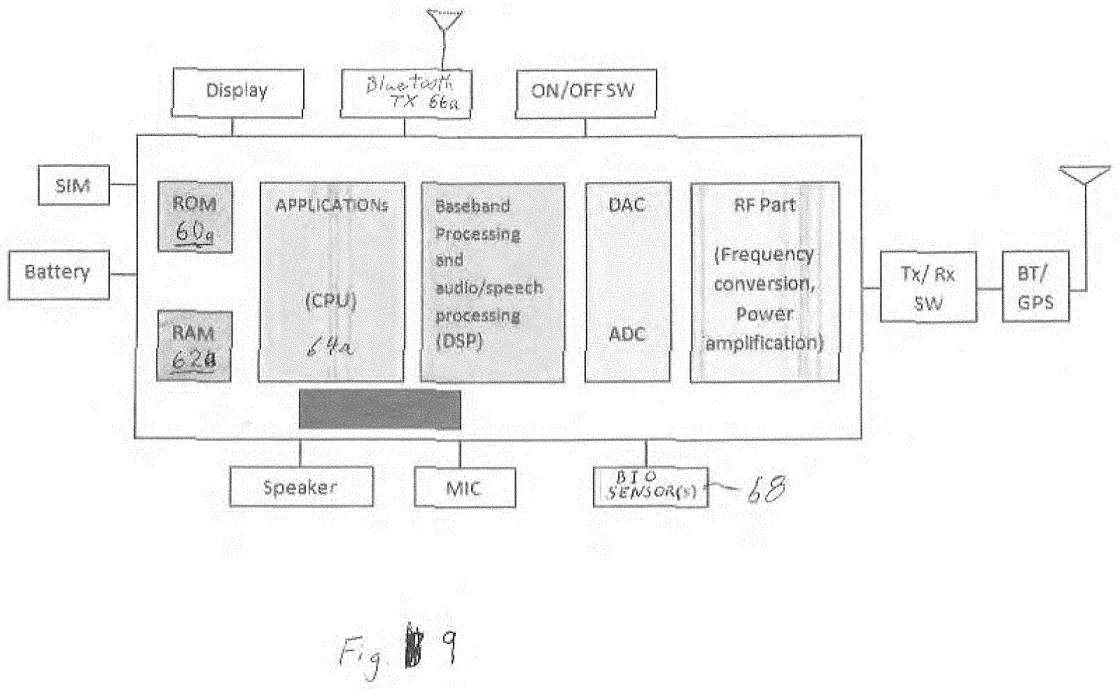

FIG. 8 is a block diagram of the major circuit components of a modern smartphone such as smartphone 4 of FIG. 1. The ROM 60 and RAM 62 memory components are those contained, for example, in an iPhone 12 or Galaxy S21 Ultra 5G. The CPU 64 of these modern smartphones combined with ROM 60 and RAM 62 are fully capable of executing a smart contract having the sequential commands required to perform the functions described above with respect to smart contract 36. Bluetooth transmitter 66 is adapted to allow smartphone 4 to communicate wirelessly with other electronic devices such as a smartwatch 6 as illustrated in FIG. 1 and as described above with respect to the subject invention.

FIG. 9 is a block diagram of the major circuit components of a modern smartwatch. These components are, broadly speaking, quite similar to the major circuit components of a smartphone but optimized to perform those functions normally performed by a smartwatch. Thus, ROM 60a and RAM 62a as well as CPU 64a are similar to the corresponding smartphone components but optimized to perform the functions normally performed by a modern smartwatch including operating Bluetooth transmitter 66a for preforming the various functions described above with respect to communicating wirelessly with the smartphone. FIG. 9 includes bio-sensor(s) 68 for measuring various bio functions of a user when the smartwatch is mounted on the user's body. Such functions include heart rate, blood pressure, skin pH, or any one or more of a number of other bio-functions that would produce personal data suitable for immutable storage in the user's personal blockchain as described above.

Implementation of the subject invention could be enhanced by the creation of an association of users (e.g. a users' union) based on a user becoming a member by downloading a DApp, designed in accordance with the subject invention, into their personal computer device(s). The function of the users association would include the creation, maintenance and upgrading of the DApp for practicing the subject invention. In addition, the users association would be responsible for popularizing and marketing the DApp to potential new user association members and to third parties who may wish to have access to the immutably stored personal data of the various association members. An important function of the user association would be to establish the conditions and fee schedules for third party data access to the immutably stored personal data. The resulting fee income could then be divided among the association members after deduction of the operating expenses of the association. Setting the third party access fees and the appropriate portion of those fees to the members would be an important function of the association so as to maximize the fee payments to the members through establishing third party access fees at a level to maximize participation by third parties desiring access to the immutably stored information of the members.

As noted above, an aspect of the subjection invention is that members who agree to download the required portions of the DApp of this invention into their smartphone (and linked smart watch). The downloadable portion of the DApp could be provided through an interface provided by the association. The downloaded portion of the DApp would allow the user's personal data to be stored in the user's personal blockchain. Users who agree to allow certain portions of their data to be searchable and temporarily accessed would, nevertheless, retain ownership of their personal data along with private encryption keys with an obligation to provide public keys to permit unlocking of personal data on a temporary basis to third party suppliers who agree to not retain the data.

In other words, the member association would have the responsibility to develop and provide the DApp embodying this invention combined with responsibility to upgrade and guarantee operability of the DApp and with responsibility for insuring that members are receiving their “value” payments for agreeing to allow their personal data to be accessed on a temporary, conditional basis. Third parties (e.g. service/product suppliers, credit agencies, governmental authorities, and others) who wish to have access to such immutable person data (encrypted into blocks of the blockchain) would be required to comply with all obligations imposed by the DApp and agree to pay the required access fees. Such fees could be split between members and the member association and could be paid via transfer of cryptocurrency supported by the blockchain.

The subject invention would permit the personal data now stored as “cookies” to be stored in the personal block chain and made available to websites on a permissioned basis so long as the user desired to make the information available. The permission could be revoked, of course, by withdrawal of permission to the third party website.

In view of the foregoing, the skilled person will readily understand the technical improvements that the present invention provides over the prior art, such as, for example, improved blockchains, data and device security, and data accuracy. The skilled person will further recognize that the invention is a practical application of certain concepts described herein.

Although the various configurations have been described in language specific to structural features and/or methodological acts, it is to be understood that the subject matter defined in the Figures is not necessarily limited to the specific features or acts described. Rather, the specific features and acts are disclosed as example forms of implementing the claimed subject matter.

1. A smartphone for providing control over data generated thereby over time as the smartphone is operated by the user, said smartphone comprising:
a processor configured to execute a DApp including a smart contract and blockchain, wherein the DApp includes:
a. first commands for allowing the smartphone, to receive user defined criteria for the smart contract to use in selecting data generated at successive times during operation of the smartphone, for immutable storage in the blockchain;
b. second commands for formatting the selected data to comply with the user defined criteria;
c. third commands for storing immutably the selected data in a new block of the blockchain; and
d. fourth commands for allowing the smartphone to receive access criteria by which the smart contract operates to grant to other devices access to data immutably stored in the blockchain under conditions complying with the data access criteria.

2. The smartphone as defined in claim 1, wherein said user defined access criteria is revocable by the smartphone in response to receipt of user defined access criteria.

3. The smartphone as defined by claim 1, wherein said blockchain transmits electronic payments to the user in the form of digital value to an account of the user as compensation for granting to other persons access to the personal data.

4. The smartphone as defined in claim 3, wherein the digital value includes government backed currency or cryptocurrency

5. The smartphone as defined by claim 4, wherein the blockchain supports transfer of the cryptocurrency via a validation and confirmation mechanism.

6. The smartphone as defined by claim 5, wherein the blockchain operates as a distributed ledger on a blockchain network including multiple nodes wherein complete copies of the blockchain exist simultaneously at multiple nodes on the blockchain network, and wherein each new block added to the blockchain requires consensus in accordance with a consensus algorithm in which cryptocurrency, supported by the blockchain, is awarded to nodes to provide consensus on each new block.

7. A method implemented by a DApp formed by a smart contract and associated blockchain for managing personal data generated in real time by linked personal computers, including a smartphone and a body mountable computer, operating to generate personal data at successive times as the user accesses the linked personal computers, wherein the smart contract causes the linked personal computers to execute steps of:
a. allowing a user's linked personal computer to receive user defined data criteria for the smart contract to use in selecting personal data, generated at successive times as the user accesses the linked personal computers, for immutable storage of the selected personal data in the blockchain;
b. formatting the selected personal data found by the smart contract to comply with the user defined data criteria;
c. storing immutably the selected data in a new block of the blockchain; and
d. allowing the linked personal computers to receive user defined access criteria by which the smart contract operates to grant to other persons access to data immutably stored in the blockchain under conditions complying with the user defined access criteria.

8. The method as defined by claim 7, wherein step (a) further includes a step of receiving the user defined data access criteria using either the smartphone or the body mountable computer.

9. The method as defined by claim 7, wherein step (b) further includes a step of formatting the personal data by including a time stamp indicating approximately the time that the personal data was generated, formatted and stored by steps a-c.

10. The method as defined by claim 7, wherein step (b) further includes a step of formatting the personal data by including the geolocation of the linked personal computers at the time the personal data is generated, formatted and stored by steps (a)-(c).

11. The method as defined in claim 7, further including a step of providing a mounting mechanism for the body mountable computer that will allow the user to access the body mountable computer more quickly than the smartphone when located in its stored position.

12. The method as defined in claim 11, wherein the step of providing a mounting mechanism includes a step of providing a wrist mounting mechanism allowing the body mountable computer to be mounted on the wrist of the user.

13. The method as defined in claim 7, wherein steps (a) and (d) are performed when the user accesses either one of the body mountable computer and smartphone.

14. The method as defined by claim 7, wherein the blockchain rewards the user in the form of government backed currency or cryptocurrency as compensation for granting to third parties access to the user's personal data.

15. The method as defined in claim 14 in which the blockchain operates as a distributed ledger on a blockchain network and complete copies of the blockchain exist simultaneously at multiple nodes on the blockchain network, and consensus in accordance with a consensus algorithm is reached on each new block added to the blockchain, wherein the blockchain further rewards cryptocurrency, supported by the blockchain, to entities operating at the network nodes to provide consensus on each new block.

16. The method as defined by claim 15, wherein the blockchain supports transfer of the cryptocurrency via a validation and confirmation mechanism.

17. A body mountable personal computer adapted to be linked to a smartphone which may be accessed by hand retrieval from a stored location on the user's body, for managing personal data generated in real time while implementing a decentralized application, wherein the body mountable personal computer comprises:
a mechanism for mounting the body mountable personal computer on the body of a user to allow quicker visual access to the body mountable personal computer than to the smartphone when in its stored position, and wherein the decentralized application includes a smart contract and blockchain including:
i. first commands for allowing the body mountable personal computer, when linked to the smartphone, to receive user defined data criteria for the smart contract to use in selecting personal data, generated at successive times, as the user accesses the linked personal computers, for immutable storage in the blockchain;
ii. second commands for formatting the selected personal data found by the smart contract to comply with the defined criteria entered by the user;
iii. third commands for storing immutably the selected data in a new block of the blockchain; and
iv. fourth commands allowing the the body mountable personal computer to receive user defined access criteria by which the smart contract operates to grant to other persons access to data immutably stored in the blockchain under conditions complying with the access criteria received by the body mountable personal computer.

18. The body mountable personal computer as defined in claim 17, wherein the body mountable personal computer is a smartwatch and said mechanism operates to mount the smartphone on the user's wrist.

19. The body mountable personal computer as defined in claim 18, wherein said smartwatch includes a biometric sensor for generating personal data suitable for immutable storage in said blockchain.

20-23. (canceled)
